(19) United States
(12) Patent Application Publication
(10) Pub. No.: US 2007/0068337 A1
(43) Pub. Date: Mar. 29, 2007

(54) Ergonomic, adjustable handle for microtomes and cryostats

(75) Inventor: Matthew Taylor Mincer, Oak Park, IL (US)

Correspondence Address: MATTHEW T. MINCER, 314 NORTH GROVE AVENUE, OAK PARK, IL, 60302, US

(73) Assignee: Matthew Taylor Mincer, Oak Park, IL (US)

(21) Appl. No.: 11/162,298

(22) Filed: Sep. 6, 2005

(51) Int. Cl. H02K 7/02

(52) U.S. Cl. 74/572.1

(57) ABSTRACT

Disclosed is a microtome or cryostat handle in which the angle of the grip is adjustable with respect to the flywheel of the devise. The handle is attached to the flywheel by a bearing block to allow for rotation. The grip of the handle is attached to the bearing block with a moveable coupler, which allows the grip to be positioned at any angle relative to the flywheel. The angle of the grip can either be locked into position or allowed to float depending on the preference of the user.

The invention relates to a microtome or cryostat drive handle having an adjustable grip. The handle allows the angle of the grip to be in adjusted so that it is in a more natural position for the human body specifically, the hand, wrist, elbow and arm. This, along with a cushioned grip, makes for a more healthy and comfortable user experience.

### HISTORY OF THE INVENTION

The present invention involves a microtome or cryostat, both of which are used to cut tissue for microscopic examination. A microtome a devise that cuts tissue that has been embedded in a medium, usually paraffin or plastic. A cryostat is a microtome that has been installed in a freezing chamber. As a result, the tissue becomes frozen and can cut more easily.

Microtomes are becoming increasingly automated with each design generation. The automation is an attempt to decrease physical stress and fatigue on the user as well as increase output as volume increases.

Automated microtomes have several distinct disadvantages:

First, automated microtomes lack the biofeedback of a manual microtome. The type, size and relative hardness of tissue varies considerable from one specimen to the next. Each specimen requires slight variations in speed and technique. This is best accomplished by feeling how the microtome responds to each specimen.

Second, automated microtomes require a substantial capital investment.

Third, manual microtomes are relatively safer. An automated microtome does not differentiate between a specimen and a finger. If an object gets trapped between the specimen and the knife, it will cut the object. The manufacturers of automated microtomes have tried to counteract this problem with an emergency stop. Unfortunately, by the time the emergency stop has been activated, it is usually too late. In fact, there have been several documented cases of fingers being cut off by automated microtomes.

As stated above, one of the reasons for microtome automation is to reduce fatigue. One of the primary causes of this fatigue is the way the handle on microtomes is positioned. The handle on most microtomes sticks out of the flywheel horizontally. This has been shown to be an unnatural position for the body and can lead to carpal tunnel syndrome. The invention as presented can help to rectify this situation.

### BRIEF DESCRIPTION OF THE DRAWINGS

FIG. 1 shows the invention in front view

FIG. 2 shows the invention as it is rotated

### DETAILED DESCRIPTION OF PREFERRED EMBODIMENTS

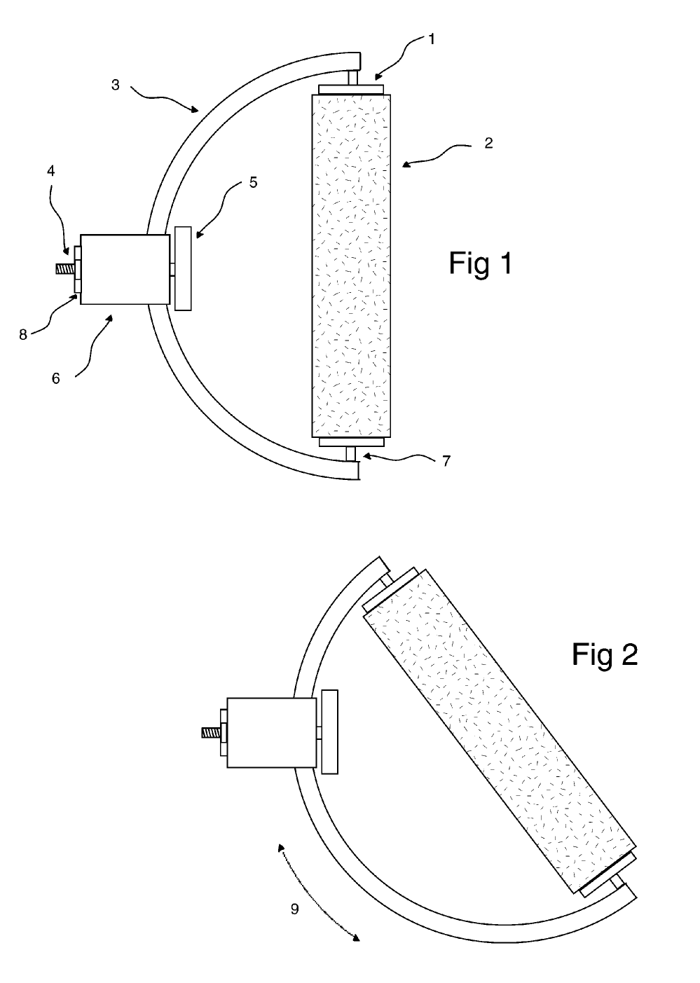

FIG. 1 shows the grip solid core 1 with grip cushion 2. The grip is attached to swing arm 3 with bushings 7. The swing arm is attached to the bearing block 6 and is locked in place by thumbscrew 5. The entire system is attached to a flywheel with a threaded rod 4 and is locked in place with a nut 8.

FIG. 2 shows how the angle of the grip can be changed 9 as the swing arm 3 rotates through the bearing block 6.

What is claimed is:

1. A microtome or cryostat handle comprising a bearing block which attaches to the flywheel of a microtome or cryostat and rotates independently of the flywheel, an adjustable grip which attaches to the bearing block and can be locked once an acceptable position has been determined, a locking system to allow the grip to be locked in position.

2. The handle as defined in claim 1, wherein the grip can be adjusted to any position from vertical to horizontal relative to the flywheel.

3. The handle as defined in claim 1, wherein the grip can be allowed for float freely within the bearing block.

4. The handle as defined in claim 1, wherein the grip maintains high lateral strength in the locked and unlocked position.
